(19) United States
(12) Patent Application Publication
(10) Pub. No.: US 2021/0366024 A1
(43) Pub. Date: Nov. 25, 2021

(54) ITEM RECOMMENDATION METHOD BASED ON IMPORTANCE OF ITEM IN SESSION AND SYSTEM THEREOF

(71) Applicant: National University of Defense Technology, Changsha (CN)

(72) Inventors: Fei CAI, Changsha (CN); Wanyu CHEN, Changsha (CN); Zhiqiang PAN, Changsha (CN); Chengyu SONG, Changsha (CN); Yitong WANG, Changsha (CN); Yanxiang LING, Changsha (CN); Xin ZHANG, Changsha (CN); Honghui CHEN, Changsha (CN)

(21) Appl. No.: 17/325,053

(22) Filed: May 19, 2021

(30) Foreign Application Priority Data
May 25, 2020 (CN) 202010450422.4

(51) Int. Cl. G06Q 30/06; G06Q 30/02

(52) U.S. Cl. CPC G06Q 30/0631; G06Q 30/0201

(57) ABSTRACT

The present disclosure provides an item recommendation method based on importance of item in a session and a system thereof. In the present disclosure, an importance extracting module extracts an importance of each item in the session, and then a long-term preference of a user is obtained in combination with the importance and the corresponding item, and then a preference of the user is obtained accurately in combination with a current interest and the long-term preference of the user, and finally item recommendation is performed according to the preference of the user. In this way, the accuracy of the item recommendation is improved

### CROSS-REFERENCE TO RELATED APPLICATION

This application claims priority from the Chinese patent application 202010450422.4 filed May 25, 2020, the content of which are incorporated herein in the entirety by reference.

### TECHNICAL FIELD

The present disclosure relates to the field of content recommendation technologies, and in particular to an item recommendation method based on importance of item in a session and a system thereof.

### BACKGROUND

Item recommendations based on session are mostly item predictions based on anonymous session with their purpose of predicting an item in which a user is likely to be interested in a next session from a given item set, and recommending the possibly interested item to the user. At present, most of the item recommendation models based on anonymous session focus on an interaction history of a user to predict a preference of the user, thereby recommending items according to the preference of the user. However, in a case of unavailability of some user-item interaction histories, it will be a big challenge to accurately capture a preference of a user.

In view of unavailability of user-item interactions, we need to generate an item recommendation based only on a current on-going session. In the some existing approaches, for example, recommendations are generated by capturing a preference of a user by applying a gated recurrent unit (GRU) to model time sequence behaviors of the user in a session, or by capturing a main intention of the user by use of an attention mechanism, or the recommendations are predicted by producing an accurate complex transfer relationship between item embedding vectors and modeling items by using a Gated Graph Neural Network (GGNN). In the existing approaches, no sufficient attention is paid to a source of important information and thus an important item in a session cannot be accurately located to generate a preference of a user. After an item embedding vector is generated, the importance of each item is determined simply based on relevance of the item and one or combination of the mixture of the items in a long-term history and the last item. Inevitably, irrelevant items may exist in a session, especially in a long session, thus it is difficult for a recommendation model to focus on the important items. Therefore, it is extremely important to propose an item recommendation model focusing on importance of items in a session in order to improve the accuracy of the item recommendation.

### SUMMARY

In view of this, the present disclosure provides an item recommendation method based on importance of item in a session and a system thereof to avoid the influence of irrelevant items in the session on a recommendation accuracy in a method of performing item recommendation based on a current session in the prior art.

Provided is an item recommendation method based on importance of item in a session, configured to predict an item that a user is likely to interact at a next moment from an item set as a target item to be recommended to the user, wherein the following steps are performed based on a trained recommendation model, including:

obtaining an item embedding vector by embedding each item in a current session to one d-dimension vector representation, and taking an item embedding vector corresponding to the last item in the current session as a current interest representation of the user;

obtaining an importance representation of each item according to the item embedding vector, and obtaining a long-term preference representation of the user by combining the importance representation with the item embedding vector;

obtaining a preference representation of the user by connecting the current interest representation and the long-term preference representation by a connection operation;

obtaining and recommending the target item to the user according to the preference representation and the item embedding vector.

Preferably, obtaining the importance representation of each item according to the item embedding vector includes:

converting an item embedding vector set formed by each item embedding vector corresponding to each item in the current session to a first vector space and a second vector space by a non-linear conversion function respectively so as to obtain a first conversion vector and a second conversion vector respectively, wherein the non-linear conversion function is a conversion function learning information from the item embedding vector in a non-linear manner;

obtaining an association matrix between the first conversion vector and the second conversion vector;

obtaining the importance representation according to the association matrix.

Preferably, obtaining the importance representation according to the association matrix includes:

obtaining an average similarity of one item in the current section and other items in the current session according to the association matrix as an importance score of the one item;

obtaining the importance representation of the one item by normalizing the importance score using a first normalization layer.

Preferably, a diagonal line of the association matrix is blocked by one blocking operation during a process of obtaining the importance representation according to the association matrix.

Preferably, the target item is obtained and recommended to the user by calculating probabilities that all items in the item set are recommended according to the preference representation.

Preferably, obtaining and recommending the target item to the user by calculating the probabilities that all items in the item set are recommended according to the preference representation and the item embedding vector includes:

obtaining each preference score of each item in the current session correspondingly by multiplying each item embedding vector by a transpose matrix of the preference representations;

obtaining the probability that each item is recommended by normalizing each preference score using a second normalization layer;

selecting the items corresponding to one group of probabilities with sizes ranked top among all probabilities as the target items to be recommended to the user.

Preferably, the recommendation model is trained with a back propagation algorithm.

Preferably, a parameter of the recommendation model is learned by using a cross entropy function as an optimization target.

Provided is an item recommendation system based on importance of item in a session, configured to predict an item that a user is likely to interact at a next moment from an item set as a target item to be recommended to a user, including:

an embedding layer module, configured to obtain each item embedding vector by embedding each item in a current session to one d-dimension vector representation;

an importance extracting module, configured to extract an importance representation of each item according to the item embedding vector;

a current interest obtaining module, configured to obtain an item embedding vector corresponding to the last item in the current session as a current interest representation of the user;

a long-term preference obtaining module, configured to obtain a long-term preference representation of the user by combining the importance representation with the item embedding vector;

a user preference obtaining module, configured to obtain a preference representation of the user by connecting the current interest representation and the long-term preference representation;

a recommendation generating module, configured to obtain and recommend the target item to the user according to the preference representation and the item embedding vector.

Preferably, the importance extracting module includes:

a first non-linear layer and a second linear layer, respectively configured to convert an embedding vector set formed by each item embedding vector by a non-linear conversion function to a first vector space and a second vector space so as to obtain a first conversion vector and a second conversion vector respectively, wherein the non-linear conversion function is a conversion function learning information from the item embedding vector in a non-linear manner;

an average similarity calculating layer, configured to calculate an average similarity of one item in the current session and other items in the current session according to an association matrix between the first conversion vector and the second conversion vector to characterize an importance score of the one item;

a first normalizing layer, configured to obtain the importance representation of the one item by normalizing the importance score.

As can be seen, in the item recommendation method based on importance of item in a session and a system thereof provided in the present disclosure, the importance extracting module extracts the importance of each item in the session, and then a long-term preference of a user is obtained in combination with the importance and the corresponding item, and then the preference of the user is accurately obtained in combination with the current interest and long-term preference of the user, and finally item recommendation is performed according to the preference of the user. In this way, the accuracy of item recommendation is improved, and the calculation complexity of the item recommendation model is reduced.

### BRIEF DESCRIPTIONS OF THE DRAWINGS

FIG. 1 is a block diagram of an item recommendation model based on importance of item in a session according to the present disclosure.

FIG. 2 is a schematic diagram of a comparison result of SR-IEM model, CSRM model, and SR-GNN model in terms of Recall@20 index of YOOCHOOSE dataset.

FIG. 3 is a schematic diagram of a comparison result of SR-IEM model, CSRM model, and SR-GNN model in terms of MRR@20 index of YOOCHOOSE dataset.

FIG. 4 is a schematic diagram of a comparison result of SR-IEM model, CSRM model, and SR-GNN model in terms of Recall@20 index of DIGINETICA dataset.

FIG. 5 is a schematic diagram of a comparison result of SR-IEM model, CSRM model, and SR-GNN model in terms of MRR@20 index of DIGINETICA dataset.

FIG. 6 is a schematic diagram of a comparison result of SR-IEM model, SR-STAMP model, and SR-SAT model in terms of Recall@20 index.

FIG. 7 is a schematic diagram of a comparison result of SR-IEM model, SR-STAMP model, and SR-SAT model in terms of MRR@20 index.

### DETAILED DESCRIPTIONS OF EMBODIMENTS

The technical solutions of the examples of the present disclosure will be fully and clearly described below in combination with the accompanying drawings of the examples of the present disclosure. Apparently, these described examples are merely some of the examples of the present disclosure rather than all examples. Other examples obtained by those skilled in the art without paying creative work based on these examples will fall within the scope of protection of the present disclosure. It should be further noted that “the” in the detailed embodiments of the present disclosure only refers to technical belonging or feature in the present disclosure.

The main purpose of an item recommendation based on session contents is to predict an item in which a user is likely to be interested at a next moment from an item set Vₜ={v₁, v₂, . . . , v_{|v|}} according to a current session and recommend it as a target item to the user. For example, the item set is Vₜ={v₁, v₂, . . . , v_{|v|}}, a current session is denoted as Sₜ, and the current session Sₜ is a session Sₜ={s₁, s₂, . . . , sₜ} formed by t items at a time stamp. In this case, the next item that the user is likely to interact (the item in which the user is likely to be interested at a next time stamp) is predicted as sₜ₊₁ from the session.

In order to improve the accuracy of performing item recommendation based on session contents, we considers the importance of item in the current session in building a recommendation model, so as to more accurately obtain a preference of a user according to the importance of item and perform item recommendation according the preference of the user. Thus, we provide an item recommendation method based on importance of item in a session, in which a next item that a user is likely to interact is predicted from an item set as a target item to be recommended to the user. The method is mainly performed by a recommendation model shown in FIG. 1 but not limited to implementation by the model shown in FIG. 1. FIG. 1 is an item recommendation model based on importance of item in a session. A system run by the item recommendation model shown in FIG. 1 is an item recommendation system based on importance of item in a session.

The item recommendation method based on importance of item in a session according to the present disclosure mainly includes the following steps performed by a trained item recommendation model (the recommendation model shown in FIG. 1).

At step 1, an item embedding vector is obtained by embedding each item in a current session to one d-dimension vector representation, and the item embedding vector corresponding to the last item in the current session is taken as a current interest representation of the user.

Firstly, the item embedding vector eᵢ, eᵢ ∈R is obtained by embedding each item xᵢ in the current session Sₜ={x₁, x₂, . . . , xₜ} to one d-dimension vector through one embedding layer, where xᵢ(1≤i≤t) refers to the i-th item in the session Sₜ. The session Sₜ is an expression of the vector, and thus sᵢ is the i-th component of the session vector. The item embedding vectors e₁, e₂, . . . , eₜ constitute the first component, the second component, . . . . the t-th component of the first column of an item embedding vector set E in sequence from top down. Considering the last item xₜ reflects the latest interaction of the user, we directly select the last component eₜ (the item embedding vector corresponding to the last item in the current session) after the embedding vector set E to represent the current interest Zₛ of the user in the current session. Thus, the current interest can be expressed in the following formula (1):

Zₛ=eₜ (1)

At step 2, an importance representation of each item is obtained according to the item embedding vector.

In order to accurately locate an important item in a session to model a preference of a user, an importance extracting module (IEM) is disposed in the recommendation model proposed by us so that the importance representation of the item xᵢ is generated according to the item embedding vector eᵢ. In the importance extracting module, two non-linear layers are enabled to convert the vector set E formed by the item embedding vectors eᵢ to a first vector space query Q and a second vector space key K through a nonlinear function sigmoid, so as to obtain a first conversion vector Q and a second conversion vector K respectively. The two conversion vectors are expressed in the following formulas (2) and (3):

Q=sigmoid(W_{q}E) (2)

K=sigmoid(WₖE) (3)

Herein, the w_{q}∈R^{d×l} and Wₖ∈R^{d×l} are trainable parameters corresponding to query and key; l is a dimension of an attention mechanism adopted in the process of performing formulas (2) and (3); and sigmoid is a conversion function learning information from the item embedding vector in a nonlinear manner.

After generation of representations of Q and K, the importance of each item may be estimated according to Q and K in the following steps.

Firstly, an association matrix between Q and K is introduced to calculate a similarity between every two items in the current session in the following formula (4):

$$C = \frac{sigmoid ( Q {K}^{T} )}{\sqrt{d}} \qquad ( 4 )$$

The \sqrt{d} herein is used to reduce the attention pro rata. In the association matrix, if similarities between one item and other items are all relatively low, it is considered that this item is not important. The user may interact with such an item occasionally or for curiosity. On the contrary, if one item is similar to most items in the session, this item may express a main preference of the user. That is, the item is relatively important. Enlightened by the above descriptions, we take an average similarity of one item and other items in a session as an importance characterization parameter of the item. In order to avoid a high similarity of same items in terms of Q and K, we apply one blocking operation to block a diagonal line of the association matrix and then calculate the average similarity. Thus, we can calculate one importance score αᵢ for each item xᵢ, which is expressed in the following formula (5):

$${α}_{i} = \frac{1}{t} {\sum }_{j = 1 , j \neq i}^{t} {C}_{ij} \qquad ( 5 )$$

Herein, Cᵢⱼ∈C. In order to normalize the importance score αᵢ, operations are performed using a softmax layer to obtain an importance representation βᵢ of the final item. The calculation formula is as follows:

$${β}_{i} = \frac{exp ( {α}_{i} )}{{\sum }_{p} exp ( {α}_{p} )} , ∀ i = 1 , 2 , … , t . \qquad ( 6 )$$

At step 3, a long-term preference of the user is obtained by combining the importance representation with the item embedding vector.

We obtain the importance representation βᵢ of each item in the session by use of the importance extracting module. The importance representation reflects a relevance of each item and a main intention of the user. Next, we obtain the long-term preference zₗ of the user by combining the importance of each item in the session with the item in the following formula (7):

$${z}_{l} = {\sum }_{i = 1}^{t} {β}_{i} {e}_{i} \qquad ( 7 )$$

At step 4, a preference representation of the user is obtained by connecting the current interest representation and the long-term preference representation through a connection operation.

After obtaining the long-term preference Zₗ and the current interest Zₛ of the user, we obtain the final preference representation of the user by combining the long-term preference and current interest in the following formula (8):

zₕ=W₀[z₁;zₛ] (8)

At step 5, the target item is obtained and recommended to the user according to the preference representation and the item embedding vector.

After the preference representation of the user is generated in the session, we generate item recommendations by calculating probabilities that all items in a candidate item set V are recommended by using the preference representation. Firstly, we calculate a preference score \hat{z}ᵢ of the user for each item in the candidate item set V through multiplication operation based on the following formula (9):

\hat{z}ᵢ=zₕ^{T}eᵢ (9)

Herein, zₕ is obtained by the formula (8), and eᵢ is an embedding vector of each item. Before the multiplication operation, the item embedding vectors constitute the first component, the second component, . . . the t-th component on the first row of the embedding vector set I from left to right in sequence. Then, a normalization probability that each item is recommended is obtained by performing normalization for each preference score using a normalization layer softmax layer.

ŷ=soft max(\hat{z}) (10)

Herein, z=(\hat{z}₁, \hat{z}₂, . . . , \hat{z}ₙ). After the normalization probability corresponding to each item is obtained, the items corresponding to a group of probabilities with size ranked top among the probabilities are taken as target items to be recommended to the user.

In order to training the model, we adopt a cross entropy function as an optimization target to learn a parameter in the following formula (11):

$$L ( \hat{y} ) = - {\sum }_{i = 1}^{n} {y}_{i} log ( {\hat{y}}_{i} ) + ( 1 - y ) log ( 1 - {\hat{y}}_{i} ) \qquad ( 11 )$$

Herein, yᵢ∈y reflects whether a particular item appears in a one-hot encoding of real purchase, that is, if the target item of the session is given at the time of the i-th item, yᵢ=1 and otherwise, yᵢ=0. Finally, we train the recommendation model using a back propagation algorithm.

The present disclosure further provides an item recommendation system based on importance of item in a session for realizing the recommendation method of the present disclosure. As shown in FIG. 1, the item recommendation system mainly includes an embedding layer module (shown in FIG. 1), an importance extracting module, a current interest obtaining module (corresponding to the current interest shown in FIG. 1), a long-term preference obtaining module (corresponding to the long-term preference shown in FIG. 1), and a recommendation generating module (not shown in FIG. 1).

The embedding layer module is configured to obtain each item embedding vector by embedding each item in the current session to one d-dimension vector representation, the importance extracting module is configured to extract the importance representation of each item according to the item embedding vector, the current interest obtaining module is configured to obtain the item embedding vector corresponding to the last item in the current session as a current interest representation of the user, the long-term preference obtaining module is configured to obtain the long-term preference representation of the user by combining the importance representation with the item embedding vector, the user preference obtaining module is configured to obtain the preference representation of the user by connecting the current interest representation and the long-term preference representation, and the recommendation generating module is configured to obtain and recommend the target item to the user according to the preference representation and the item embedding vector. The importance extracting module further includes a first nonlinear layer and a second linear layer (nonlinear layers are shown in FIG. 1) which are used respectively to convert the embedding vector set formed by the item embedding vectors to the first vector space and the second vector space through a nonlinear conversion function, so as to obtain the first conversion vector Q and the second conversion vector K, where the nonlinear conversion function is a conversion function learning information from the item embedding vector in a nonlinear manner. The importance extracting module further includes an average similarity calculating layer, configured to calculate an average similarity of one item in the current session and other items in the current session according to an association matrix between the first conversion vector and the second conversion vector to characterize an importance score of the one item and a normalization layer, configured to obtain the importance representation of the one item by normalizing the importance score.

In order to verify the effectiveness and the recommendation accuracy of the recommendation method based on importance of item in a session and the system thereof in the present disclosure, we perform evaluation for the item recommendation method and the system thereof in the present disclosure on two reference datasets YOOCHOOSE and DIGINETICA, where the statistic data of the datasets YOOCHOOSE and DIGINETICA are shown in the following Table 1.

TABLE 1

| DATA | YOOCHOOSE | DIGINETICA |
|---|---|---|
| CLICK | 557,248 | 982,961 |
| TRAINING | 369,859 | 719,470 |
| SESSION | | |
| TEST | 55,898 | 60,858 |
| SESSION | | |
| ITEM | 16,766 | 43,097 |
| AVERAGE | 6.16 | 5.12 |
| SESSION | | |
| LENGTH | | |

We verify the effect of the item recommendation method provided by us by comparing the performance of the item recommendation model SR-IEM based on importance of item in a session in the present disclosure with the performance of 8 existing reference models based on session recommendation, where the 8 reference models include three traditional methods (S-POP, Item-KNN and FPMC) and five neural models (GRU4REC, NARM, STAMP, CSRM and SR-GNN). The two datasets used by use for evaluation are two disclosed reference e-merchant datasets, i.e. YOOCHOOSE and DIGINETICA. We set a maximum session length as 10, that is, we only consider the latest 10 items in a case of excessive session length. The item embedding vector and the dimension of the attention mechanism are set to d=200 and l=100 respectively. We adopt Adam as an optimizer with an initial learning rate set to 10⁻³, which attenuates by 0.1 for every three cycles. The batch size is set to 128. Further, we use the Recall@20N and the MRR@N index to evaluate the effects of the item recommendation model SR-IEM based on importance of item in a session and various reference models with N set to 20 in our experiment. Table 2 shows the comparison results of the performances of the item recommendation model SR-IEM provided by the present disclosure and eight existing reference models based on session recommendation, where the optimal reference model and the results of the optimal model in each column are highlighted with underlines and bold ▴ for representation of t test. It can be seen from Table 2 that the neural network models of the eight existing reference models are generally superior to the traditional method. For example, SR-GNN performs best in terms of two indexes on the YOOCHOOSE dataset, whereas the item recommendation model SR-IEM provided by the present disclosure has much better performance than the optimal reference models. However, the CSRM model performs best in terms of Recall@20 on the DIGINETICA dataset. With application of GGNN model, the SR-GNN model can model a complex inter-item transfer relationship to produce an accurate user preference. Based on the NARM model, the CSRM model introduces a neighbor session so that it performs better than other reference models. Therefore, we select CSRN and SR-GNN as reference models in the subsequent experiments.

TABLE 2

| | YOOCHOOSE | | DIGINETICA | |
|---|---|---|---|---|
| Method | Recall@20 | MRR@20 | Recall@20 | MRR@20 |
| S-POP | 30.44 | 18.35 | 21.06 | 13.68 |
| Item-KNN | 51.60 | 21.81 | 35.75 | 11.57 |
| FPMC | 45.62 | 15.01 | 31.55 | 8.92 |
| GRU4REC | 60.64 | 22.89 | 29.45 | 8.33 |
| NARM | 68.32 | 28.63 | 49.70 | 16.17 |
| STAMP | 68.74 | 29.67 | 45.64 | 14.32 |
| CSRM | 69.85 | 29.71 | 51.69 | 16.92 |
| SR-GNN | 70.57 | 30.94 | 50.73 | 17.59 |
| SR-IEM | 71.11 ▴ | 31.23 ▴ | 52.32 ▴ | 17.74 ▴ |

Next, we focus on the performance of the item recommendation model SR-IEM provided by the present disclosure. Generally, the SR-IEM model is superior to all reference models in the two indexes of the two datasets. For example, on the YOOCHOOSE dataset, the SR-IEM model has an increase of 2.49% in terms of MRR@20 over the best reference model SR-GNN, which is higher than the increase of 0.82% in terms of Recall@20. Conversely, on the DIGINETICA dataset, the increase on Recall@20 is higher than the increase on MRR@20 for the possible reason of the size of the item set. SR-IEM is more capable of increasing the ranking of the target item in a case of fewer candidate items, and is more effective in hitting the target item in a case of more candidate items.

Further, we analyze the calculation complexities of the SR-IEM model and two best reference models (CSRM model and SR-GNN model). For the CSRM model and the SR-GNN model, the calculation complexities are O(td²+dM+d²) and O(s(td²+t³)+d²) respectively, where t refers to a session length, d refers to a dimension of an item embedding vector, M refers to a number of neighbor sessions introduced by the CSRM model, and s refers to a number of training steps in GGNN. For the SR-IEM model, the calculation complexity is O(t²d+d²), which mainly comes from the importance extracting module O(t²d+d²) and other modules O(d²). Because t<d and d<<M, the calculation complexity of the SR-IEM is obviously lower than the SR-GNN and CSRM. In order to verify the point empirically, we compare the training times and the test times of the SR-IEM model, the CSRM model and the SR-GNN model. We find that the time consumption of the SR-IEM model is obviously smaller than the CSRM model and the SR-GNN model. It indicates that compared with the reference models, the SR-IEM model performs best in terms of recommendation accuracy and the calculation complexity, providing feasibility for its potential application.

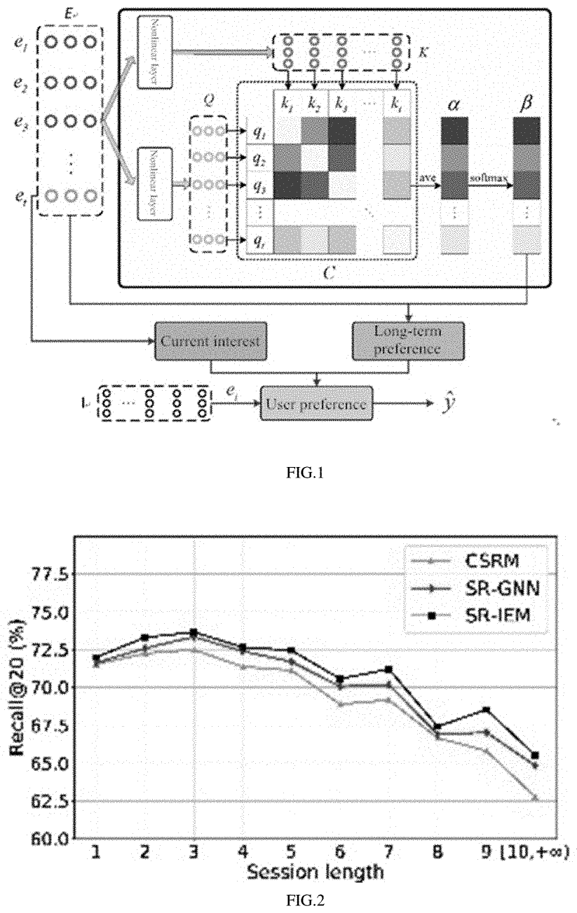

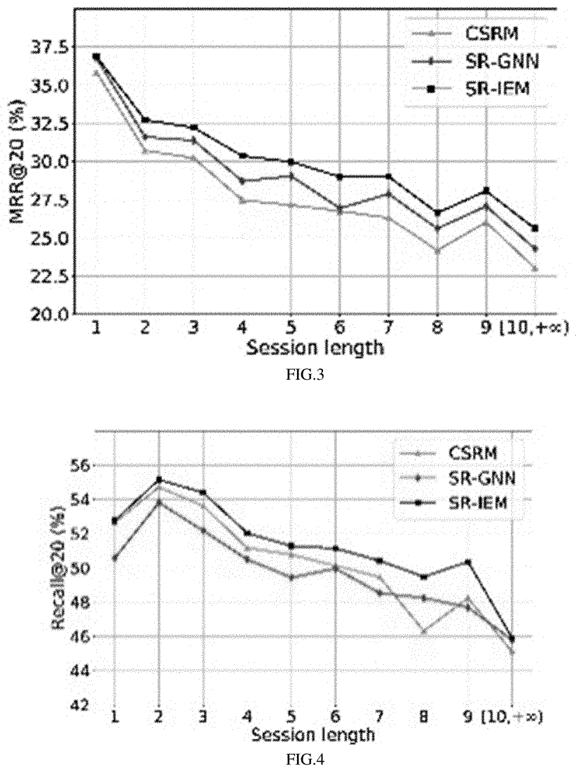

Further, the influence of the session length on the effect of the item recommendation model SR-IEM model provided by the present disclosure is analyzed in the present disclosure as shown in FIGS. 2-5. FIG. 2 is a schematic diagram of a comparison result of SR-IEM model, CSRM model, and SR-GNN model in terms of Recall@20 index of YOOCHOOSE dataset. FIG. 3 is a schematic diagram of a comparison result of SR-IEM model, CSRM model, and SR-GNN model in terms of MRR@20 index of YOOCHOOSE dataset. FIG. 4 is a schematic diagram of a comparison result of SR-IEM model, CSRM model, and SR-GNN model in terms of Recall@20 index of DIGINETICA dataset. FIG. 5 is a schematic diagram of a comparison result of SR-IEM model, CSRM model, and SR-GNN model in terms of MRR@20 index of DIGINETICA dataset. From FIGS. 2-5, we can see that the performances of the three models firstly increase and then continuously decrease along with the increase of the session length. According to the comparison result of Recall@20 index, it can be seen that the SR-IEM has a much larger increase on the session length of 4-7 than the increase on the session length of 1-3 compared with the CSRM model, and the SR-GNN model. The reasons is as follows: when the session length is excessively short, the importance extracting module IEM in the item recommendation model SR-IEM model provided by the present disclosure is not capable of distinguishing the importances of items well, but has a better effect along with the increase of the length. According to the comparison result of the MRR@20, it can be seen that the performances of the SR-IEM model, CSRM model, and SR-GNN model show a trend of continuous decrease along with increase of the session length. On the YOOCHOOSE dataset, the SR-IEM model performs better than the CSRM model, and SR-GNN model in all lengths. However, on the DIGINETICA dataset, the SR-GNN model performs better in some lengths, for example, in the lengths of 4 and 5. Further, on the YOOCHOOSE dataset, the SR-IEM model has a continuous decrease in terms of MRR@20 rather than firstly has an increase in terms of Recall@20. Further, on the DIGINETICA dataset, the score of the SR-IEM model in terms of MRR@20 decreases faster than in terms of Recall@20. The differences of the SR-IEM model in terms of Recall@20 and MRR@20 on the two datasets may be because the irrelevant items in a short session have a larger unfavorable effect on MRR@20 than on Recall@20.

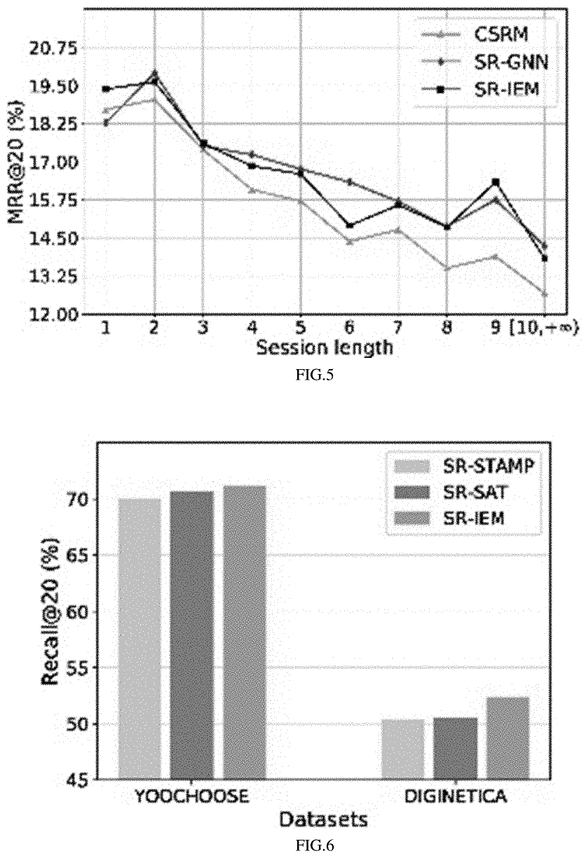

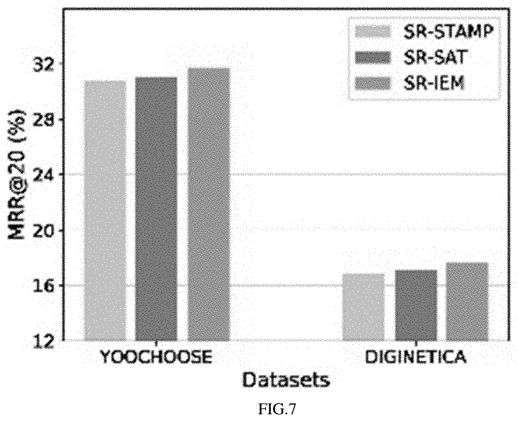

In order to verify the effect of the importance extracting module IEM in the item recommendation model SR-IEM model provided by the present disclosure in improving the item recommendation accuracy, we obtain a variation item recommendation model of the present disclosure by substituting two substitute modules for the IEM module in the SR-IEM model. For the first variation, the first variation item recommendation model SR-STAMP model of the present disclosure is obtained by replacing the importance extracting module IEM in FIG. 1 with an existing attention mechanism module, and the mixture of all items and the last item in the SR-STAMP model session are regarded as the “key” relevance amount of the present disclosure. For the second variation, the importance extracting module IEM in FIG. 1 is replaced with another existing attention mechanism to distinguish the importances of the items, and then the second variation item recommendation model SR-SAT model of the present disclosure is obtained by aggregating the importances with the average pooling strategy. Then, we compare the performances of the SR-IEM model, the SR-STAMP model and the SR-SAT model in terms of Recall@20 index and MRR@20 index with a comparison result shown in FIGS. 6 and 7. FIG. 6 is a schematic diagram of a comparison result of SR-IEM model, SR-STAMP model, and SR-SAT model in terms of Recall@20 index. FIG. 7 is a schematic diagram of a comparison result of SR-IEM model, SR-STAMP model, and SR-SAT model in terms of MRR@20 index.

Generally, the SR-IEM model performs best in terms of Recall @20 index and MRR@20 index on the two datasets and the SR-SAT model performs better than the SR-STAMP model. This is possibly because the SR-SAT model considers the relationship between items in the context of the session and is capable of capturing a user preference so as to produce a correct item recommendation, and the SR-STAMP model determines the importance of item by only using the mixture of all items and the last item, and thus cannot represent a preference of a user accurately. In addition, it is difficult for the SR-SAT model and the SR-STAMP model to remove irrelevant items in the session, which have negative effect on the recommendation performance. It can be seen that the IEM module proposed by us can effectively locate the important item, and allocate a higher weight to them at the time of modeling the preference of the user, so as to avoid interference of other items in the session.

As can be seen, in the item recommendation method based on importance of item in a session and a system thereof provided in the present disclosure, the importance extracting module extracts the importance of each item in the session, and then a long-term preference of a user is obtained in combination with the importance and the corresponding item, and then the preference of the user is accurately obtained in combination with the current interest and long-term preference of the user, and finally item recommendation is performed according to the preference of the user. In this way, the accuracy of item recommendation is improved, and the calculation complexity of the item recommendation model is reduced.

The examples of the present disclosure do not exhaust all possible details nor limit the present disclosure to the specific examples of the present disclosure. Many changes and modifications may be made according to the above descriptions. The specific examples of the present disclosure are used only to explain the principle and the actual application of the present disclosure better, so that those skilled in the art may use the present disclosure well or change the present disclosure for use. The present disclosure is only limited by the claims, and its entire scope of protection and equivalents.

What is claimed is:

1. An item recommendation method based on importance of item in a session, configured to predict an item that a user is likely to interact at a next moment from an item set as a target item to be recommended to the user, wherein the following steps are performed based on a trained recommendation model, comprising:
obtaining an item embedding vector by embedding each item in a current session to one d-dimension vector representation, and taking an item embedding vector corresponding to the last item in the current session as a current interest representation of the user;
obtaining an importance representation of each item according to the item embedding vector, and obtaining a long-term preference representation of the user by combining the importance representation with the item embedding vector;
obtaining a preference representation of the user by connecting the current interest representation and the long-term preference representation by a connection operation;
obtaining and recommending the target item to the user according to the preference representation and the item embedding vector.

2. The item recommendation method according to claim 1, wherein obtaining the importance representation of each item according to the item embedding vector comprises:
converting an item embedding vector set formed by each item embedding vector corresponding to each item in the current session to a first vector space and a second vector space respectively by a non-linear conversion function so as to obtain a first conversion vector and a second conversion vector respectively, wherein the non-linear conversion function is a conversion function learning information from the item embedding vector in a non-linear manner;
obtaining an association matrix between the first conversion vector and the second conversion vector;
obtaining the importance representation according to the association matrix.

3. The item recommendation method according to claim 2, wherein obtaining the importance representation according to the association matrix comprises:
obtaining an average similarity of one item in the current section and other items in the current session according to the association matrix as an importance score of the one item;
obtaining the importance representation of the one item by normalizing the importance score using a first normalization layer.

4. The item recommendation method according to claim 2, wherein,
blocking a diagonal line of the association matrix by one blocking operation during a process of obtaining the importance representation according to the association matrix.

5. The item recommendation method according to claim 1, wherein the target item is obtained and recommended to the user by calculating probabilities that all items in the item set are recommended according to the preference representation.

6. The item recommendation method according to claim 5, wherein obtaining and recommending the target item to the user by calculating the probabilities that all items in the item set are recommended according to the preference representation and the item embedding vector comprises:
obtaining each preference score of each item in the current session correspondingly by multiplying each item embedding vector by a transpose matrix of the preference representations;
obtaining the probability that each item is recommended by normalizing each preference score using a second normalization layer;
selecting the items corresponding to one group of probabilities with sizes ranked top among all probabilities as the target items to be recommended to the user.

7. The item recommendation method according to claim 1, wherein the recommendation model is trained with a back propagation algorithm.

8. The item recommendation method according to claim 1, wherein a parameter of the recommendation model is learned by using a cross entropy function as an optimization target.

9. An item recommendation system based on importance of item in a session, configured to predict a next item that a user is likely to interact from an item set as a target item to be recommended to the user, comprising:
an embedding layer module, configured to obtain each item embedding vector by embedding each item in a current session to one d-dimension vector representation;
an importance extracting module, configured to extract an importance representation of each item according to the item embedding vector;
a current interest obtaining module, configured to obtain an item embedding vector corresponding to the last item in the current session as a current interest representation of the user;
a long-term preference obtaining module, configured to obtain a long-term preference representation of the user by combining the importance representation with the item embedding vector;
a user preference obtaining module, configured to obtain a preference representation of the user by connecting the current interest representation and the long-term preference representation;
a recommendation generating module, configured to obtain and recommend the target item to the user according to the preference representation and the item embedding vector.

10. The item recommendation system according to claim 9, wherein the importance extracting module comprises:
a first non-linear layer and a second linear layer, respectively configured to convert an embedding vector set formed by each item embedding vector by a non-linear conversion function to a first vector space and a second vector space so as to obtain a first conversion vector and a second conversion vector respectively, wherein the non-linear conversion function is a conversion function learning information from the item embedding vector in a non-linear manner;
an average similarity calculating layer, configured to calculate an average similarity of one item in the current session and other items in the current session according to an association matrix between the first conversion vector and the second conversion vector to characterize an importance score of the one item;
a first normalizing layer, configured to obtain the importance representation of the one item by normalizing the importance score.
